(19) United States
(12) Patent Application Publication
(10) Pub. No.: US 2011/0186758 A1
(43) Pub. Date: Aug. 4, 2011

(54) Hydraulic Motor With Non-Contact Encoder System

(75) Inventors: Bradley J. Goldbeck, Delano, MN (US); Calvin J. Brandt, Delano, MN (US)

(73) Assignee: Calbrandt, Inc., Delano, MN (US)

(21) Appl. No.: 12/697,433

(22) Filed: Feb. 1, 2010

(51) Int. Cl. F16K 31/12; B23P 17/00

(52) U.S. Cl. 251/59; 29/888

(57) ABSTRACT

A disc valve hydraulic motor assembly is disclosed that includes a rotary valve that rotates in accordance with the motor output shaft and in which a two-pole bolt magnet is mounted in alignment with the center of the rotating valve to rotate with the rotating valve. The end housing of the disc valve hydraulic motor that is spaced from and disposed beyond the rotating valve is provided with a central opening aligned with the magnet. A stainless steel plug is interposed between the sensor and the interior of the motor so that the sensor is separated from the high pressure hydraulic fluid.

### CROSS-REFERENCED TO RELATED APPLICATIONS

Not applicable

### STATEMENT REGARDING FEDERALLY SPONSORED RESEARCH OR DEVELOPMENT

Not applicable

### BACKGROUND OF THE INVENTION

I. Field of the Invention

The present invention relates generally to hydraulic motors and, more particularly, to controlling the operation of disc valve hydraulic motors using an integral non-contact encoder system to generate control signals.

II. Related Art

Many devices have used external signals to control the operation of hydraulic motors, however, there yet remains a need to obtain more precise operation control of such motors by using feedback information gained by an integral non-contact encoder system using a rotating magnet which has heretofore not been incorporated in such motors. Such a system could be used to control motor operation using a programmable logic controller (PLC), or the like, to control rpm's or precisely position the motor shaft for tool alignment purposes, or the like.

### SUMMARY OF THE INVENTION

By means of the present invention, there is provided a disc valve hydraulic motor assembly that includes a rotary valve that rotates in accordance with the motor output shaft and in which a two-pole bolt magnet (N/S 180° apart) is mounted in alignment with the center of the rotating valve to rotate with the rotating valve. The corresponding end housing of the disc valve hydraulic motor that is spaced from and disposed beyond the rotating valve is provided with a central opening or port aligned with the magnet. A non-contact sensor encoder is mounted in the opening in the housing to receive signals from the rotating magnet. The encoder also has an internal magnet that magnetically couples to the magnet in the motor so that the encoder rotates in the same manner as the magnet bolt. This provides the motor with an integral feedback system. A stainless steel plug device is provided in the opening in the end housing such that it is interposed between the internal parts of the motor exposed to high pressure hydraulic fluid and the non-contact sensor encoder to isolate the encoder from the hydraulic fluid pressure that it would have to endure if it was exposed to the inside of the motor. It has been found that using stainless steel for such a plug avoids interference with the operation of the magnet and sensor encoder.

A method of modifying a hydraulic motor having a rotating disc valve is also contemplated in accordance with the provision of the magnet and non-contact sensor encoder. It should be noted that the output from the sensor encoder is an analog, quadrature or SSI signal which becomes an input to a controller. In this manner, the encoder provides feedback information which, in turn, can be used by a control device to control a hydraulic valve that operates the hydraulic motor, or the like, according to a control program. Thus, the feedback system provides a unique way of knowing the position of the output shaft or the speed of the output shaft which can be used for precisely aligning the motor shaft with an object to operate a tool or closely controlling the rpm's of the motor. Thus, the system can be associated with a programmable logic controller (PLC) or any of many other types of systems that will occur to those skilled in the art.

### BRIEF DESCRIPTION OF THE DRAWINGS

In the drawings:

FIG. 1 is a perspective view of a disc valve motor of a class suitable for modification using the present invention;

FIG. 2A is a partially exploded view of an end section of a hydraulic motor similar to that shown in FIG. 1 showing modifications including the present invention;

FIGS. 2B, 2C and 2D are top, side and perspective views, respectively, of the hydraulic motor fragment of FIG. 2A;

FIG. 3A is an end view of the motor of FIGS. 2A-2D;

FIG. 3B is a sectional view along lines 3A-A of FIG. 3A; and

FIG. 4 depicts a picture of a hydraulic motor that has been modified with the encoder system of the present invention showing an output connection on the end opposite to output shaft.

### DETAILED DESCRIPTION

A detailed description of an embodiment of the present invention follows which is presented as an example of a typical embodiment to allow an understanding of the inventive concepts involved. It will be understood, however, that the embodiment presented is intended merely as an example and is not meant to limit the scope of the invention in any manner.

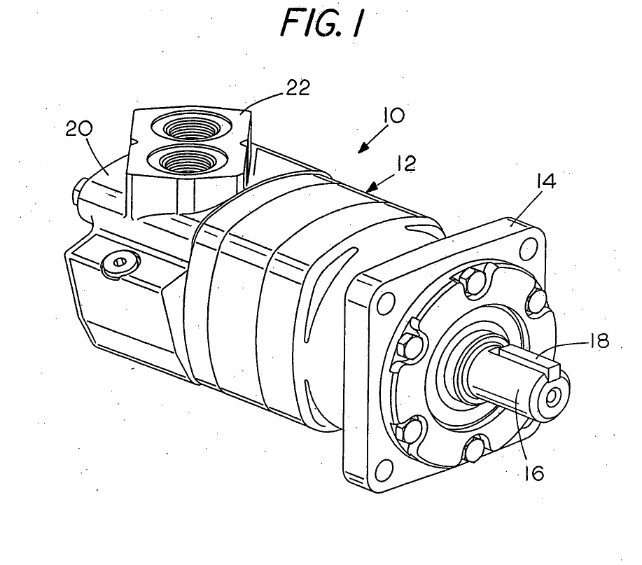

In FIG. 1, there is shown a perspective view of a disc valve hydraulic motor of a class suitable for modification by the present invention. The motor, generally at 10, includes a housing 12 and including a bolt-on output end 14 with rotary output shaft 16. A key is shown at 18 for keying the motor shaft to a rotating output device. A housing end 20 further includes a hydraulic fluid manifold 22, including input and output hydraulic fluid accesses.

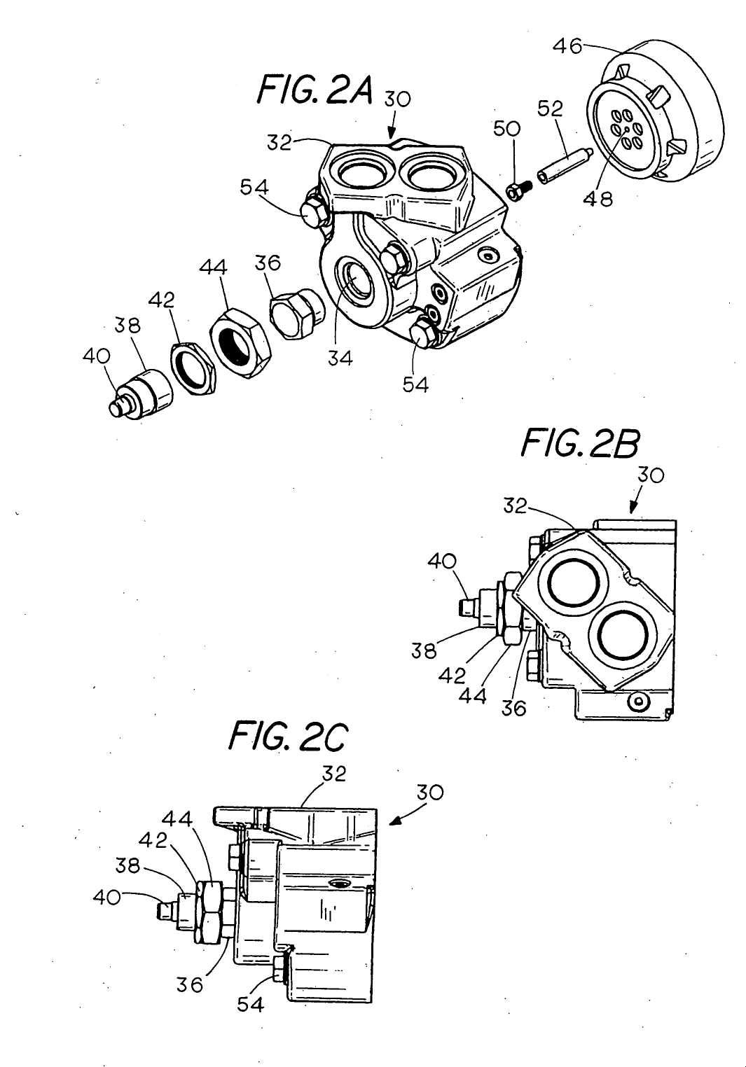

FIG. 2A shows a partially exploded view of an end portion or fragment of a hydraulic motor similar to that shown in FIG. 1, showing modifications including the present invention. Thus, part of the housing is shown at 30, including a hydraulic manifold 32. The outer wall of the housing 30 is provided with a port 34 which opens to the inside of the motor. The port is provided with a stainless steel plug 36 which seals the port 34, using an o-ring (not shown). A non-contact encoder is shown at 38 with output connection 40 which is attached to the plug utilising a stainless steel encoder jam nut 42 in conjunction with a stainless steel encoder carrier nut 44. The hydraulic motor rotary valve is shown at 46 and is provided with a tapped hole 48 for receiving a magnet bolt 50 utilizing a threaded magnet bolt extension 52. Housing bolts are shown in port at 54.

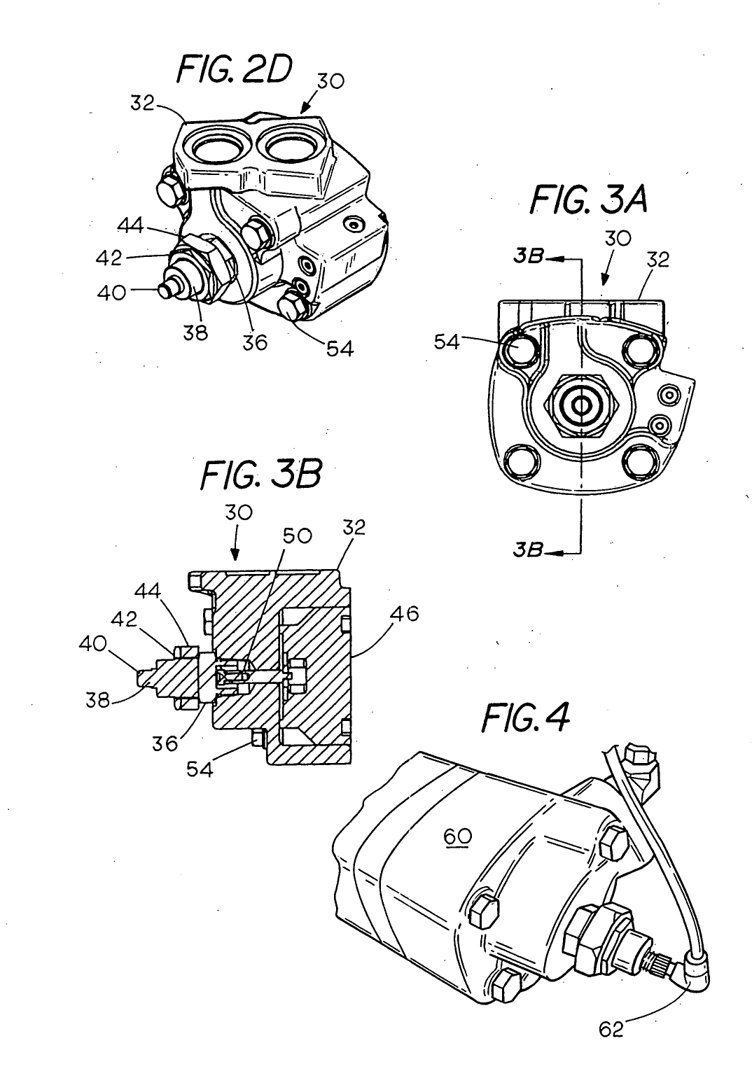

The hydraulic motor fragment of FIG. 2A is shown assembled in the views 2B, 2C and 2D which are respectively top, side and perspective views of the motor fragment. A front view is shown in FIG. 3A and a sectional view in FIG. 3B which clearly depict the assembled relationship of the parts.

In operation, of course, the magnet bolt 50 in extension 52 rotates with the rotating hydraulic motor valve 46 such that, when the motor is operated, the magnet bolt 50 assumes a permanent alignment with the motor shaft such as the shaft shown at 16 in FIG. 1. The non-contact sensor encoder 38 is separated from the magnet bolt 50, but only by stainless steel plug 36, which does not interfere with the magnetic coupling between the encoder and the magnet bolt in the motor so that motor shaft orientation and speed are constantly known to the non-contact encoder. The non-contact encoder then generates a signal which can be transmitted to any type of control device desired where it will be utilized in a well known manner. Such an output is shown, for example, on the attached cord 62 shown on the motor 60 in FIG. 4.

Thus, one such use of the signal received from sensor 38 is to control the precise alignment of the motor shaft 16 so that a tool such as a chuck (not shown) attached to the shaft can be precisely aligned to operate a remote device. In addition, motor rpm and other qualities can be precisely controlled. It will be appreciated that the signal from the sensor 38 can be used in conjunction with a programmable logic controller (PLC) which may be programmed to produce an analog, digital or SSI output.

It should be noted that a motor of the class suitable for modification in accordance with the present invention may be an Eaton 6000 Series, for example, manufactured by Eaton Corporation having an office at Eden Prairie, Minn. A non-contact encoder of the class suitable for use in the present invention may be obtained, for example, from Joral Corporation of New Berlin, Wis., as a 16 mm or 16 mm non-contact sensor encoder, which is operable with a variety of magnets, including bolt magnets, in a well known manner.

This invention has been described herein in considerable detail in order to comply with the patent statutes and to provide those skilled in the art with the information needed to apply the novel principles and to construct and use embodiments of the example as required. However, it is to be understood that the invention can be carried out by specifically different devices and that various modifications can be accomplished without departing from the scope of the invention itself.

What is claimed is:

1. A disc valve hydraulic motor assembly comprising:
(a) a rotary valve in said motor that rotates with a motor output shaft;
(b) a two-pole magnet mounted in alignment with the center of said rotating valve to rotate with said rotating valve and said output shaft;
(c) an, end housing spaced from said rotating valve and having a central opening therein aligned with said magnet;
(d) a non-contact sensor encoder mounted in said opening in said end housing; and
(e) a plug device in said opening in said end housing interposed between said non-contact sensor encoder and the interior of said motor housing such that said non-contact sensor encoder is isolated from pressurized hydraulic fluid within said motor.

2. A hydraulic motor as in claim 1 wherein said magnet is a bolt magnet mounted on an extension threadably attached to the center of said rotating valve.

3. A hydraulic motor as in claim 1 wherein said plug is made of a stainless steel that does not interfere with the operation between said magnet and said sensor.

4. Reserved

5. A method of modifying a hydraulic motor having a rotary disc valve comprising:
(a) equipping the motor to include a rotating magnet in the center of said rotating valve;
(b) providing the motor with a non-contact encoder device spaced from and aligned with said magnet and mounted in an opening in an end housing of said motor; and
(c) interposing a plug in said end housing opening separating said non-contact encoder device from the internal portion of said motor such that it is not exposed to motor hydraulic fluid pressure.
